(19) United States
(12) Patent Application Publication
(10) Pub. No.: US 2006/0174993 A1
(43) Pub. Date: Aug. 10, 2006

(54) Display with self-illuminatable image and method for making the display substrate and for making the image

(75) Inventors: Yuri A. Bery, Bonita Springs, FL (US); Douglas L. Osterberg, Menasha, WI (US)

Correspondence Address: BIRCH STEWART KOLASCH & BIRCH, PO BOX 747, FALLS CHURCH, VA, 22040-0747, US

(73) Assignee: APPLETON COATED, LLC

(21) Appl. No.: 11/346,180

(22) Filed: Feb. 3, 2006

Related U.S. Application Data
(60) Provisional application No. 60/649,536, filed on Feb. 4, 2005.

(51) Int. Cl. H01J 9/227

(52) U.S. Cl. 156/67

(57) ABSTRACT

A substrate has a self-illuminatable image. The substrate, which can be paper, will first receive conductive ink. The substrate can be calendered to provide a smooth, sealed surface for the ink. On top of the conductive ink, one or more dielectric layers can be provided followed by a phosphor-containing layer. A smoothing layer can then be provided. A second layer of conductive ink is provided on the smoothing layer. The conductive layers can be applied in any desired pattern. The first underlying conductive ink layer and the second overlying conductive ink layer will match the image in certain portions. When a current is passed through the conductive inks, phosphor in the phosphor-containing layer will be excited in order to illuminate the image. After printing of the first conductive layer, the substrate can be calendered to help connect conductive particles in the ink. A one-sided or two-sided display can be provided.

This nonprovisional application claims priority under 35 U.S.C. §119(e) on U.S. Provisional Application No. 60/649,536 filed on Feb. 4, 2005, the entire contents of which are hereby incorporated by reference.

### FIELD OF THE INVENTION

The present invention is directed to a substrate and a method for making the substrate, which has a self-illuminatable image. More particularly, the present invention is directed to a paper substrate on which conductive ink is placed in order to form indicia, which can be illuminated. A power source and a controller are provided for powering and controlling the display.

### BACKGROUND OF THE INVENTION

Heretofore, illuminatable displays have been very expensive to produce. Generally, such displays were not made on paper and require expensive display units. The substrates for these displays have been made on synthetic films or glass. While these substrates were more expensive or less environmentally friendly than paper, problems were encountered in attempting to make an illuminatable display on a substrate and in particular, on a paper substrate.

For example, the surface of paper had generally been too rough to receive an illuminatable display. In prior attempts, it was found that the paper was absorbent such that application of electrically conductive inks for the display would require a considerable quantity of ink. Moisture found in paper would migrate to the surface of the paper and diminish and eventually destroy light emitting properties. Also, insufficient paper thermal conductivity would result in excessive heat (temperature) buildup. Generally, variations in surface topography and paper formation would result in poor uniformity of light emitted from the display.

Therefore, it is an object of the present invention to provide a method whereby an image can be placed on a flexible substrate, such as paper, and which image can be self-illuminated.

A further object of the present invention is to provide such a substrate, such as paper, on which an image can be placed which is illuminatable. Placement of this image can be through printing or other techniques.

It is an object of the present invention to provide a paper substrate which is treated in order to accommodate roughness on the paper surface, to prevent excessive absorption of inks applied to the surface of the paper and to prevent moisture within the paper from affecting the display.

A further object of the present invention is to provide a method of providing conductive ink on a substrate, which method improves the conductivity of ink.

A further object of the present invention is to provide a substrate with a controller and a power source, in order to illuminate an image on the substrate.

Another object is to provide a substrate which can have a display on both sides of the substrate. This can be the same or different image.

Yet another object of the invention is to provide a diffusion layer to help even out the light emitted from the display and to provide a uniformly illuminated display.

Still a further object of the invention is to provide overlying layers of conductive ink on a display in such a manner to increase light emission from a self-illuminating image by minimizing blocking of light by the upper layers.

These and other objects are fulfilled by a method for making a display having a self-illuminatable image thereon, the method comprises the steps of providing a substrate, calendering the substrate, applying an image to be illuminated on the substrate and providing an electrical connection to supply power to the image when the image is to be illuminated.

These and other objects are also fulfilled by a method for making a display having a self-illuminatable image, the method comprises the steps of providing a substrate and placing a first layer of conductive ink on the substrate. The conductive ink has a plurality of conductive particles. The method then applies pressure to the substrate and conductive ink to connect the conductive particles in the ink to ensure a continuous electrical connection through the first layer. This pressure can be obtained by calendering of the substrate and the first layer of conductive ink. Heating the substrate and conductive ink during the step of calendering can further enhance this electrical connection. The heat will decrease the viscosity of the conductive ink to help ensure an electrical connection between the conductive particles in the ink.

These and other objects are further fulfilled by a display having a self-illuminatable image, the display comprises a substrate, a first layer of conductive ink printed on a first side of the substrate and a phosphor-containing layer provided on an opposite side of the substrate. A second layer of conductive ink is printed on the side of the substrate with the phosphor-containing layer such that the substrate acts as a dielectric layer. In this way, a two-sided display can be obtained.

These objects and other objects are also fulfilled by a display having a self-illuminatable image, the display comprises a substrate, a first layer of conductive ink and a second layer of conductive ink. At least a portion of the first layer is below a portion of the second layer such that the first and second layers overlap at portions of the image to be illuminated. A phosphor-containing layer is provided between the first and second layers of conductive ink. A source will supply an electric current to both the first and second layers, with phosphor in the phosphor-containing layer being excited to be illuminated in areas of the overlap between the first and second layers. A diffusion layer is provided above the second layer of conductive ink to increase uniformity of light emitted by the phosphor-containing layer.

Moreover, these and other objects are fulfilled by a display having a self-illuminatable image, the display comprising a substrate, a first layer of conductive ink and a second layer of conductive ink. At least a portion of the first layer is below a portion of the second layer such that the first and second layers overlap at portions of the image to be illuminated. A phosphor-containing layer is provided between the first and second layers of conductive ink. A source will supply an electric current to both the first and second layers, with phosphor in the phosphor-containing layer being excited to be illuminated in areas of the overlap between the first and second layers. A smoothing layer is provided beneath the second layer. The smoothing layer provides a flat surface for printing of the second layer of conductive ink so that an amount of ink for this second layer can be minimized. This smoothing layer also minimizes electrical resistance in the second layer.

The method of making a display having a self-illuminatable image further fulfills these and other objects by providing a substrate and then printing a first layer of conductive ink in a first predetermined pattern on the substrate. A phosphor-containing layer is provided over the first layer of conductive ink. A second layer of conductive ink is printed above the phosphor-containing layer in a second predetermined pattern, the first predetermined pattern and the second predetermined pattern overlapping at portions of the image to be illuminated. A smoothing layer is provided directly beneath the second layer to minimize the amount of conductive ink in the second layer. This smoothing layer provides a flat surface for printing of the second layer of conductive ink. This smoothing layer also minimizes electrical resistance in the second layer.

These and other objects are fulfilled by a two-sided display having a self-illuminatable image. The display includes a first substrate and a second substrate joined together. A first conductive layer is between the first and second substrates. A second top conductive layer is on a side of the first substrate opposite to the first conductive layer and a second bottom conductive layer is on a side of the second substrate opposite the first conductive layer. The first substrate and the second substrate act as a dielectric between the conductive layers.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a plan view of a substrate having a first illuminatable display;

FIG. 2 is a plan view of an initial manufacturing step for a second illuminatable display on a substrate;

FIG. 3 is similar to FIG. 2, but shows a next step in the manufacture;

FIG. 4 is a subsequent step after the step shown in FIG. 3;

FIG. 5 is a subsequent step after the step shown in FIG. 4;

FIG. 6 is a schematic cross-sectional view of an illuminatable substrate;

FIG. 7 is a top plan view of a first pattern for an upper conductive ink layer on the substrate of the present invention;

FIG. 8 is an enlarged view of a portion of FIG. 7, showing a first illumination effect;

FIG. 9 is a view similar to FIG. 8, but showing a second illumination effect;

FIG. 10 is a view similar to FIG. 8, but showing a second pattern for an upper conductive layer of ink on the substrate of the present invention;

FIG. 11 is a schematic cross-sectional view of a second embodiment of an illuminatable substrate;

FIG. 12 is a schematic cross-sectional view of a third embodiment of an illuminatable substrate;

FIG. 13 is a schematic cross-sectional view of an embodiment for providing a display on both sides of joined substrates;

FIG. 14 is a graph showing the relationship between pressure for the calender settings and temperature versus a percentage drop in resistance; and

FIG. 15 is a schematic cross-sectional view of another embodiment of a two-sided display based on the substrate of FIG. 6.

### DETAILED DESCRIPTION OF THE PREFERRED EMBODIMENTS

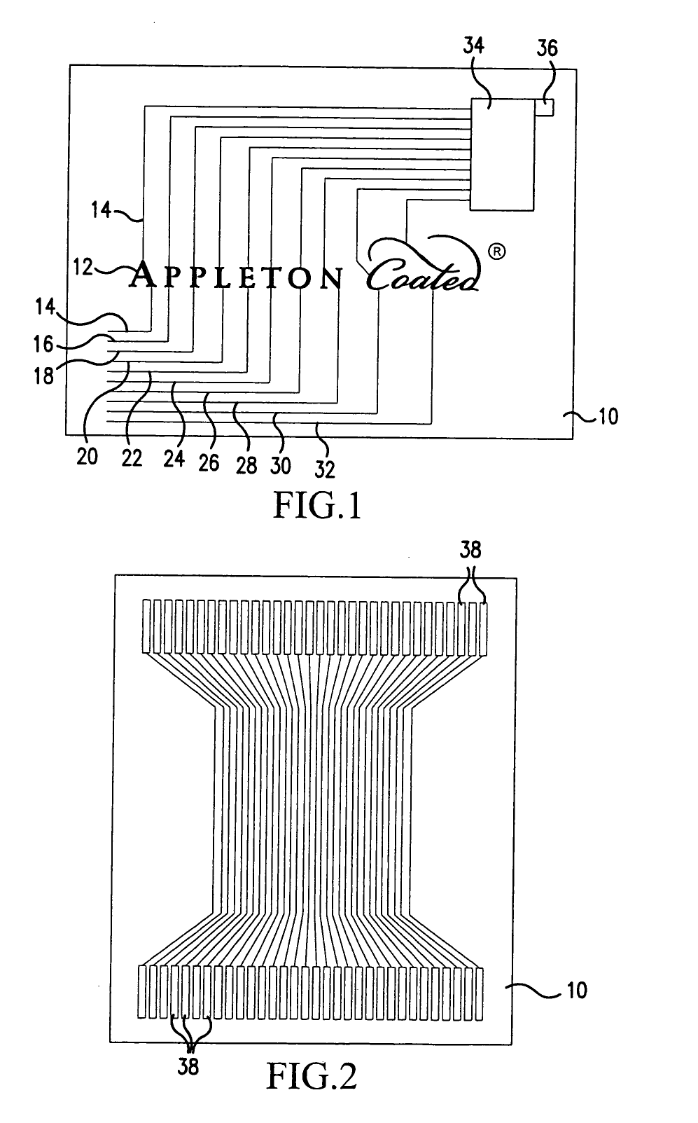

Referring in detail to the drawings and with particular reference to FIG. 1, a substrate 10 is shown. This substrate may be made of plastic, paper board, metals, non-metals, ceramic, pulp-based products, such as paper, cardboard, and cloth, as well as a combination of various materials. It is contemplated that this substrate will be malleable and flexible, but can also be inflexible if so desired. A preferred material for the substrate will be paper. This substrate may be made from a single layer or a plurality of layers. While a flat rectangular shape 10 is shown, any shape of substrate can be used. Also, the substrate 10 can be curved, shaped to conform to the image 12, or provided in any desired shape. Additionally, an article of manufacture could be used with indicia placed thereon. It is simply the case that this indicia will be illuminatable as will be explained below.

Indicia such as an image 12 is printed on the substrate. The image 12 shown in FIG. 1 is the words “APPLETON COATED”. This is just one example of any type of image which can be placed on the substrate 10. As will be explained hereinbelow, this image can be self-illuminated. The illumination can be constant or intermittent, such that the illuminated image flashes. In the provided example, the entire image can be illuminated or different portions of the image can be sequentially illuminated. For example, the different letters for “APPLETON” can be sequentially illuminated or illuminated constantly or in any desired combination. While the words “APPLETON COATED” have been utilized, any suitable image, including drawings, photographs, etc. can be placed on the substrate 10.

By providing an illuminatable image, an attractive display can be had. Furthermore, this display can be controlled to illuminate different portions of the image 12 placed on the substrate 10. Therefore, the message displayed on the substrate 10 can be changed as desired. This has several beneficial results. An electronic page or book could be provided. If a pixilated display was provided on each page of the book, the images displayed on each page could be varied. Thus, by using a controller, the pages of the book could show a first text. The controller or program could be changed and then the same book would display a different text on its pages. Such a book would have the look and feel of a conventional book as well as the advantages of an electronic book.

Other uses for the invention include a greeting card, poster, game board, signage or other images with a changeable and/or illuminatable display. Other advertising can be provided, for example. If paper stock is the substrate 10, this is relatively inexpensive to produce and an inexpensive display, as compared to existing changeable displays, can be obtained. The invention can be used for a display of a phone, which is much thinner and cheaper to manufacture than existing displays. There are a wide variety of uses contemplated for this invention. The contents of U.S. Pat. No. 6,753,830 B2 to Gelbman are incorporated herein in their entirety by reference.

As has been illustrated in FIG. 1, the different letters in the image 12 have lead lines 14-32 attached thereto. Since the first portion of the image “APPLETON” consists of separated letters, each letter has one lead line 14, 16, 18, 20, 24, 26, and 28 going thereto. The second portion of the image, “Coated” consists of a first letter “C” standing alone, as well as the rest of the word written in script. Therefore, only two lead lines 30 and 32 are connected to this portion of the image 12. For each of the lead lines 14-32, leading to the image 12, a second set of lead lines are provided.

The upstream and downstream lead lines, as well as the image 12, are merely printed on the substrate 10 with electrically conductive ink. 100431 For example, an ink having silver particles dispersed therein can be used. When the ink dries on the paper, it will permit electricity to pass therethrough in a known manner. Other conductive inks which can be used are known and include materials such as copper, gold, carbon, or conductive polymers.

Downstream from the lead lines is a controller 34. This controller 34 is shown mounted on the face of the substrate 10. However, a separate controller 34 can be provided and attached to the lead lines provided on the substrate 10. Adjacent to the controller 34 is a power source 36. The controller 34 and power source 36 can act as means for illuminating the image 12. This can be a battery or other means of power. If a battery is used, it can be printed directly on the substrate 10. The controller or portions thereof could also be printed directly on substrate 10. The power source 36 and controller 34 can be on the same side or different sides of the substrate 10. Instead of placing the controller 34 and power source 36 on the face of the substrate 10, they can be embedded in the substrate or placed on the rear surface thereof. Again, a controller 34 and power source 36, which are detached from the substrate, can also be used.

The lead lines 14-32 coming from the image 12 are shown as being connected to the controller 34. It should be understood that the upstream portion of the lead lines on the other side of the image 12 are also connected in order to provide a complete circuit. As will be explained hereinbelow, power can be supplied from the power source 36 and controlled by the controller 34. Then current will pass through each of the lead lines 14-32 as desired. Therefore, the letters of the image 12 can be sequentially or simultaneously illuminated as desired.

While a written image 12 is provided, it should be understood that any type of image can be utilized. For example, this could be a picture or photograph, geometric shapes, or any desired image. Again, the entire contents of U.S. Pat. No. 6,753,830 A2 to Gelbman are hereby incorporated by reference. Great flexibility can be had with the present invention. Also, it is contemplated in FIG. 1 that the image is generally flush with the face of the substrate 10. However, a three-dimensional image can be provided. As will be explained, conductive ink can be selectively placed on the selected image in order to illuminate the desired portions thereof.

While it has been explained that the portions of the image 12 can be selectively illuminated, it is also possible to provide a pixel type display, such that an animated image is possible. The construction of a display having pixels will now be described, beginning with reference to FIG. 2. In this FIG. 2, a substrate 10 is again shown. If paper is the substrate 10, this can be any desired grade of paper. The paper can be calendered and/or coated if so desired. The paper can be further coated to provide a sealed smooth surface. This coating can include varnishing, aqueous coating or ultraviolet (uv) curable coating or any combination of these. Calendering of the substrate also acts to seal and smooth the surface. In fact, the substrate can be either calendered or coated or both calendered and coated. By sealing the paper, its porosity can be decreased and less ink can be required. Also, a sharper image is possible. Such treating of the substrate can add costs, but such costs are minimal when compared to the costs of displays currently available. Apart from modifications to the substrate, improved resolution of the printed image can be obtained by different inks and/or printing techniques.

On the substrate 10, a plurality of conductive lines 38 are provided. These lines 38 will form the first layer of conductive ink. In the example shown in FIG. 2, thirty-two conductive lines 38 are shown. However, any suitable number of lines can be provided. Additionally, these do not have to be straight lines or lines at all, but instead can have different forms, as has been discussed above with regard to FIG. 1.

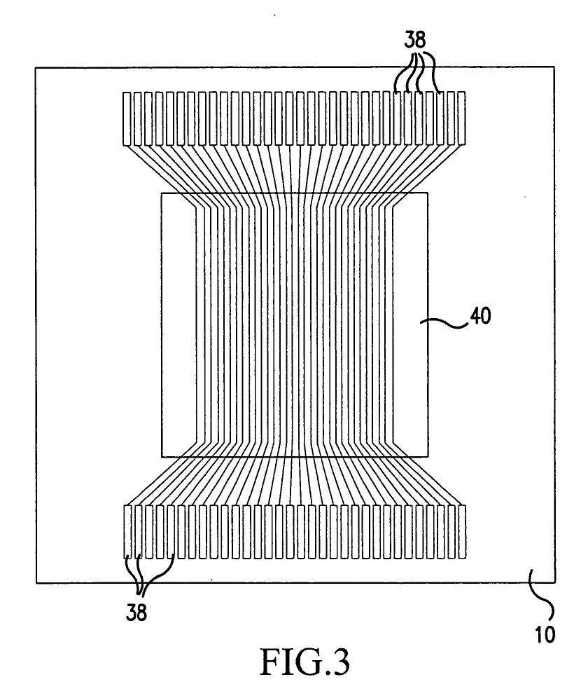

It is contemplated that the conductive lines 38 will be printed on the substrate, such as paper. This can be done by a silkscreen process or other known printing processes. After the step of printing the conductive lines 38, a dielectric layer 40 is applied over a portion of the lead lines 38. This dielectric layer 48 is a non-conductive material typically but not exclusively containing barium titanate or titanium dioxide; other dielectric materials are known. While a rectangular shape is shown in FIG. 3, any suitable design can be provided. It is contemplated that two or more layers of dielectric material will be placed on top of the conductive lines 38. The material of the dielectric layer 40 can be spread in a first direction for the first layer, and then spread in a second direction for the second layer, in order to evenly coat the area. By using two layers of dielectric material, pinholes or other defects can be minimized such that a short-circuit for the system can be avoided.

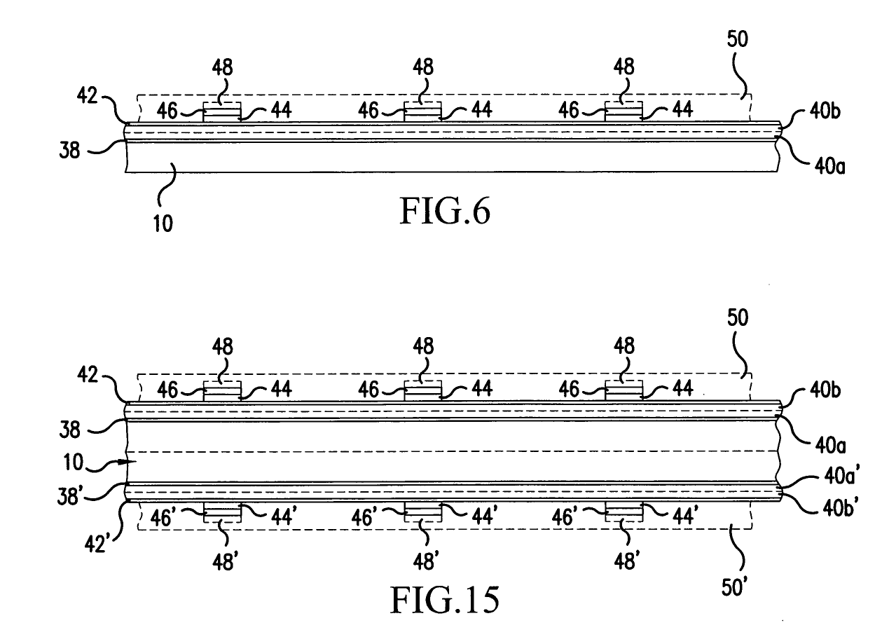

After the dielectric layer 40 has dried, a phosphor-containing layer 42 is applied in generally the same area. This is shown as having the same rectangular shape as the dielectric layer 40 in FIG. 3, but this is not necessary. The shape of the dielectric layer and the phosphor-containing layer 42 do not have to match. The phosphor-containing layer 42 can also be seen in the sectional view of FIG. 6. Also, a first dielectric layer 40a and a second dielectric layer 40b are indicated in FIG. 6 to show the two layers. However, any suitable number of layers or a single layer of dielectric material 40 can be utilized as discussed above.

On top of this dielectric layer, the phosphor-containing layer 42 is provided. For the phosphor-containing layer 42, it is contemplated that it will be between 30 and 40 microns, for example. A uniform layer is desired in order to provide good light emission. It has been found that providing extra phosphorous will actually decrease the efficiency of the illuminated image. A greater current is also required for illumination and extra costs are incurred for the extra phosphorous.

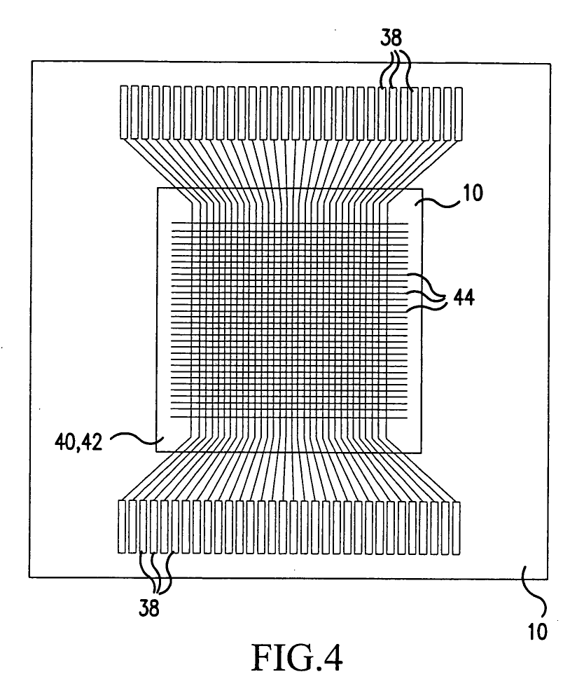

Next, a smoothing layer 44 may be placed on top of the phosphor-containing layer 42 as shown in FIGS. 4 and 6. This smoothing layer 44 helps to smooth the surface over the phosphor-containing layer 42 and can balance the conductivity of the combined top conductive layers 44 and 46. The smoothing layer 44 can be a weak conductive layer. The smoothing layer 44 is laid down in a series of lines. On top of the smoothing layer, a second series of conductive lines 46 are printed. These conductive lines 46 will make a second layer of conductive ink. These conductive lines can be placed on the smoothing layer 44 by printing or other known techniques. The shape for the smoothing layer 44 and the second conductive lines 46 should match. In other words, when lines are utilized for both the smoothing layer 44 and second conductive lines 46, they should then register. However, it is possible for the smoothing layer 44 to be wider than or have a different shape from the second conductive lines 46.

The smoothing layer 44 serves to enhance the luminescent performance of the product, but it is possible to make the product without this layer. It is also possible to make a product with this layer but without the top conductive layer 46. Additionally, the smoothening effect from layer 44 improves the performance of the second conductive lines 46 by reducing the effective length of the circuit. Thus, the smoothing layer 44 minimizes electrical resistance for the second layer and also decreases an amount of ink needed for the second conductive lines 46.

While first conductive lines 38 (first layer), second conductive lines 46 (second layer) and smoothing layer 44 being in lines has been discussed, it is contemplated that these elements can be in any desired shape or configuration. This would simply depend on the image desired. In the present invention, a pixel arrangement can be provided. Therefore, series of lines are laid down. It is noted that the first conductive lines 38 are printed in an orthogonal direction from the second conductive lines 46. Therefore, the lines 38, 46 will intersect at various points to form a plurality of pixels. This will provide the display, as will be explained below. Also, different patterns can be used for the different layers of conductive ink.

Returning to FIG. 6, a diffusion layer 48 can be provided on top of each second conductive line 46. Of course, selected lines 46 or all of the lines 46 could omit this layer 48. This layer 48 will act to increase the uniformity of light, as will be explained. It can be made from calcium carbonate or kaolin or mixtures containing these substances, for example, and it will help to spread out the light from the phosphor-containing layer 42. Of course, other known reflective surface materials can be used. In particular, upon providing a current from the power source 36 through the conductive lines or layers 38 and 46, the phosphor-containing layer 42 can be excited in order to emit light. At the intersection of two conductive lines 38 and 44 which have a current supplied thereto, the phosphor will be excited in order to illuminate at this point. Thus, a pixilated display can be achieved. Through the controller 34, it can be arranged that light is emitted in a selected area.

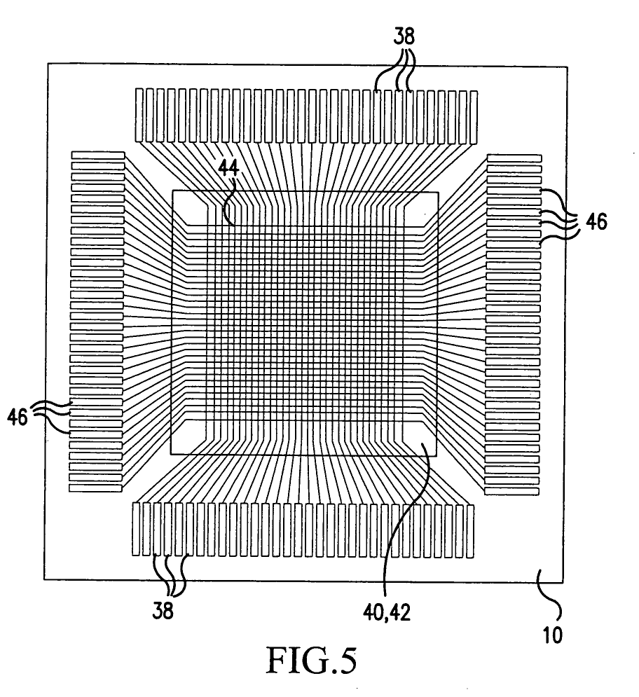

Alternatively, in a non-pixilated image 12, as shown in FIG. 1, for example, the entire letter can be illuminated rather than just a single point. The lower conductive line 38 for the “A” in “APPLETON” includes the printed lead line 14 both upstream and downstream from the “A” Accordingly, the “A” in this image will have a lower conductive line 38 and a second, upper conductive line 46, which will illuminate the entire “A”. Between the lower and upper conductive lines which are printed as an “A” in this example, a dielectric layer 40, a phosphor-containing layer 42, and a smoothing layer 44 can be provided. Also, a diffusion layer 48 can be provided on the upper conductive line. Rather than overlying at a single point as in the FIG. 5 example, the first conductive line 38 and second conductive line 46 overlie each other in the area forming the “A” letter in this example.

Returning to FIG. 6, a protective layer 50 can be provided over the entire image and/or all lead lines, if so desired. In fact, the controller 34 and power source 36 can be encapsulated in this protective layer 50, if so desired. While a relatively thick protective layer 50 has been indicated in FIG. 6, any desired thickness of protective layer can be provided. Moreover, this layer can be omitted if so desired. It is nonetheless contemplated that this protective layer 50 can help protect the printed substrate from weathering and provide insulation to protect from electric shock or damage to the various components.

Turning to FIG. 7, a pattern for the second conductive lines 46 is shown. In particular, in the midsection 52 of the second conductive lines 46, a crisscross or “X” pattern is shown. As has been explained, both the first conductive lines 38 and the second conductive lines 46 can be made from electrically conductive ink. This is simply an ink which has silver particles therein, for example. Other metal particles can be used. Such inks are known. Nonetheless, such an ink would merely permit electricity to pass therethrough in order to form a circuit.

In the FIG. 7 arrangement, the midsection 52 is printed in an “X” or crisscross shape. Each individual line will not touch, in order to prevent a short circuit. Therefore, depending upon the needs of the illuminated image, different printing techniques can be used. If a finer printing image is needed, then better inks or printing processes can be used. Also, the type of paper used can be varied as noted above. The inks can be printed with a lithographic conductive ink by offset printing, or with a flexo-conductive ink, or with other printing techniques, up to and including Gravure printing. However, a simple screen-printing technique can be utilized.

When the ink is printed, it has a tendency to migrate. Sufficient space must be provided between adjacent first conductive lines 38 and between adjacent second conductive lines 46 in order to prevent contact therebetween. If there were such contact, then the lines would short-circuit one another. By using different printing techniques as discussed, finer lines can be provided and therefore higher resolution is possible.

In the midsection 52 shown in FIG. 7, the printed “X” or crisscross shape enables light emitted from the excited phosphor-containing layer 42 to escape. Therefore, visibility of the image is improved. The ink of the second conductive lines 46 would block light passing therethrough. Therefore, it is desired to maximize the output of light in open screen such as a crisscross or “X” shape pattern has been utilized. Alternatively, layer 46 could be a substantially clear or transparent conductive material and thus printed in a solid line format rather than the open screen or “X” pattern.

The midsection 52 is just one portion of the printed pattern for the second conductive lines 46. There are leads from this midsection to enlarged end portions. These leads, as well as the end patterns, are also printed on the substrate with the midsection. It is contemplated that this is a single printing step. The enlarged end portions merely aid connection of the printed second conductive lines to the controller 34 or to leads from the controller 34. Enlarged portions at the end of the printed second conductive lines can be omitted.

The first conductive lines 38 have a shape as seen in FIG. 2, which is similar to the second conductive lines 46. As has been explained, they are merely printed in opposite directions to provide a plurality of pixels for the display. It is not necessary for the midsection of the first conductive lines 38 to have an “X” or criss-cross shape since light will not pass therethrough. However, if the substrate 10 were transparent or translucent, such a pattern for the midsection could also be utilized to enhance light emission through the rear of the substrate 10. Also, enlarged end portions are not shown for the first conductive lines 38, but they could be provided.

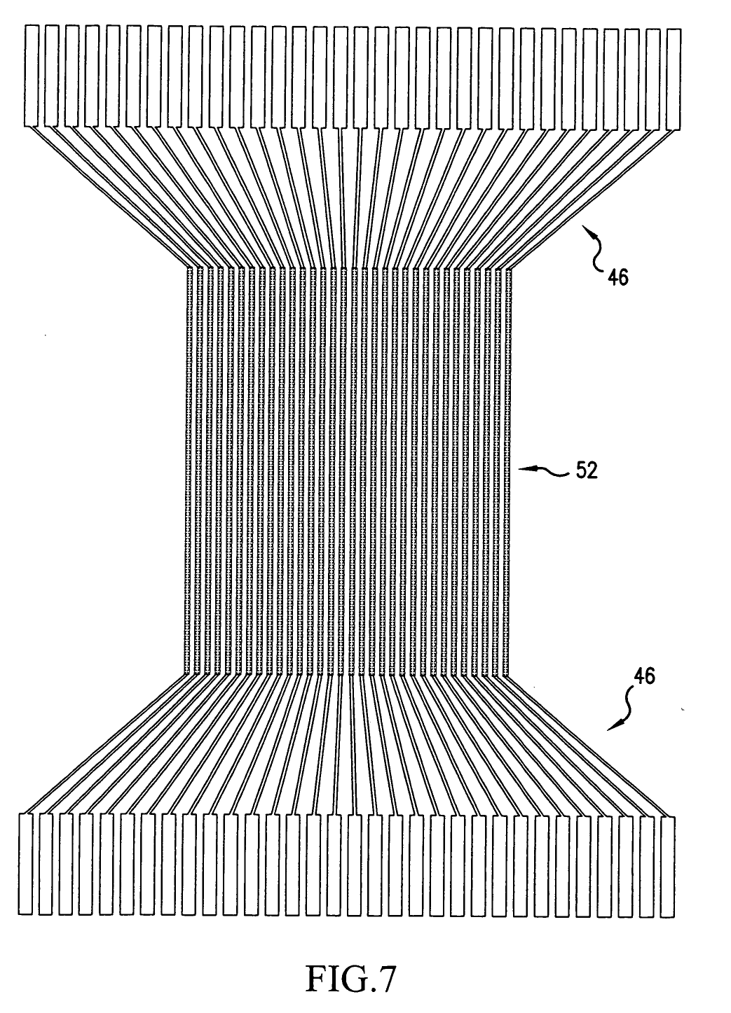

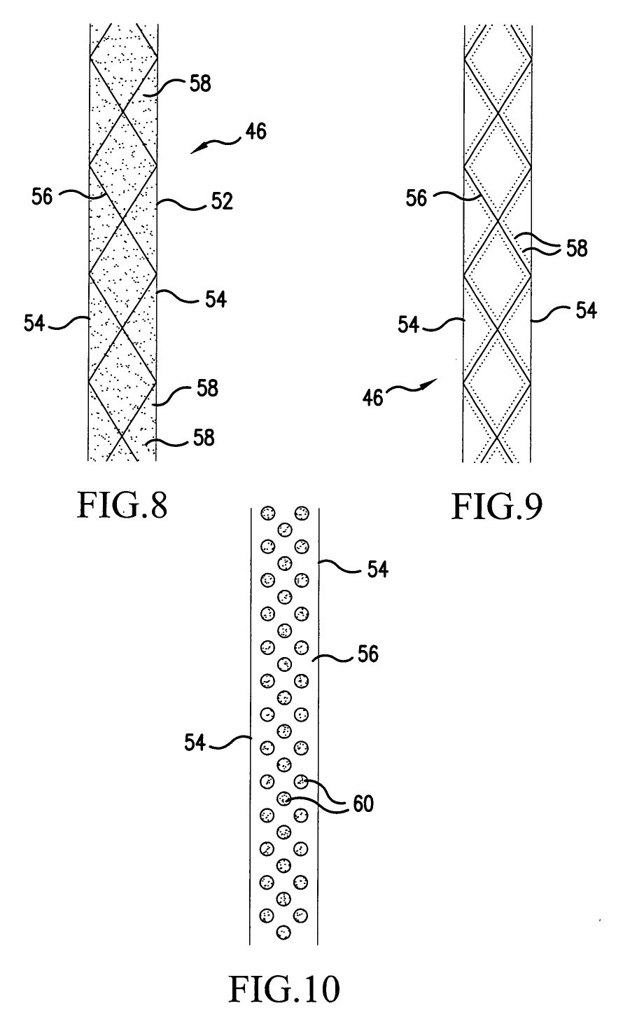

An exploded view of the midsection 52 of one of the second conductive lines 46 is shown in FIG. 8. The edges of the lines for the smoothing layer 44 are indicated. Within this area, conductive ink 56 is laid down in the crisscross screen pattern. The dots 58 represent excited phosphor particles. The human eye would generally not see such dots without magnification but would instead see a glow over the full area. This showing of dots 58 merely schematically illustrates the illuminated phosphor-containing layer. As seen in FIG. 8, there is a relatively even distribution of illumination. This is enhanced by the use of diffusion layer 48, which helps to spread out the light. If the design of the printed screen, e.g. the “X” pattern, is too coarse, diffusion layer 48 is not utilized, an arrangement as shown in FIG. 9 is obtained. In this arrangement, the light emission tends to be clustered as shown by dots 58 around the conductive ink lines 56.

Instead of using a crisscross pattern for the conductive ink, this conductive ink 56 can be laid down with a series of openings 60 therein, as shown in FIG. 10. While a pattern of openings 60 is shown in FIG. 10, it is not necessary to have any particular pattern. The ink 56 will basically cover the underlying layers. Therefore, the more openings 60 which are provided, the more light will be emitted. However, sufficient ink 56 must be provided in order to provide the electrical field necessary for excitation of the underlying phosphor-containing layer 42.

When the image including the second conductive lines 46 is made by a screen printing process, the crisscross or “X” shape as shown in FIGS. 8 and 9 has been found to be beneficial. The screen through which the ink is printed will be a mesh. This mesh will cause slight interruptions in laying down the ink layer. These interruptions are very small, but the crisscross shape can be laid down in a pattern, which is not aligned with the mesh or crisscross shape of the screen. Therefore, a maximum supply of ink can be obtained. However, any suitable pattern for the conductive ink 56 of the second conductive lines 46 can be utilized.

In the different steps of laying down the layers of the present invention, it is important that they are adequately dried. This helps prevent formation of short-circuits and other problems.

One technique, which has been found useful in improving the conductivity of the conductive ink, is to calendar the ink after the formation of the image. In particular, at least after the first conductive lines 38 have been laid down, the image can be calendered. It is preferred to do this before additional layers are applied thereto. It has been found that the calendar can help crush the ink in order to connect the conductive particles. During the calendering process, heat can be applied in order to further encourage the ink to make a circuit. The temperature is such that the viscosity of the conductive ink in line 38 is decreased whereby the conductive particles are forced into contact. This will increase the electrical conductivity of the first layer.

FIG. 14 shows a plot of pressure (calender settings) in pounds per square inch and temperature (° C.) versus percentage drops in resistance. Thus, it can be seen that with increased temperature and pressure, the resistance will decrease for the first conductive lines 38. A preferred pressure range has been found to be 200-1000 psi while a preferred temperature range would be 100-200° C. these ranges could further be reduced to 150-200° C. and 500-1000 psi. The temperature effect on conductivity is such that the volume of the liquid phase is significantly reduced further enhancing the physical contact among the conductive particles in the conductive ink. This results in an overall increase in ink conductivity.

Another technique, which has been found useful, is to control the printing temperature. Either the substrate or the inks can be cooled down. In particular, the ink can be cooled down and, when it dries, the conductive particles will expand in order to improve contact between the silver or other conductive particles. Therefore, a better circuit can be obtained.

Because conductive ink is relatively expensive, it is desired to minimize the amount of ink used. Uncalendered paper can have a rough surface. By printing on a calendered sheet of paper, less ink can be used. The paper is flatter and less valleys and ridges are present. Accordingly, the line of printed ink has less distance to travel. Less ink can be used and the travel distance for the current passing through this conductive line is reduced. This not only helps minimize costs, but will also decrease the amount of current needed in order to cause illumination of the phosphor-containing layer.

Also, if calendering or other process is used to flatten the substrate, such as the paper, an electrical connection is better ensured. If there are ridges and valleys in the substrate, the conductive particles have difficulty making contact in these regions. Removing such ridges and valleys and providing a flatter substrate improve the connection between the conductive particles in the line 38.

To improve image resolution, it is possible to smooth and/or seal the paper surface with a coating layer such as is commonly used in the printing industry, e.g. aqueous coating, varnish, or UV curable coating. The paper could be coated with calcium carbonate, kaolin or any other suitable coating. Such coatings help increase electrical breakdown resistance. It is also possible to coat over the phosphor-containing layer 42 with similar transparent coating before the smoothing layer 44 and second lines 46 are applied thereto. Coating the phosphor-containing layer 42 and/or substrate 10 will help smooth out the surface. The phosphor tends to provide a rough surface. Also, uncalendered paper can be rough. Microscopically, various valleys and ridges or other imperfections are present in the paper's surface as noted above. A straighter smoothing layer 44 and second conductive lines 46 can be obtained. This can use less ink and reduce resistance so that less power is required. Also, the use of such coatings can improve resolution of the image. It has been found that resolution can be quadrupled in a coated sheet of paper versus an uncoated sheet of paper.

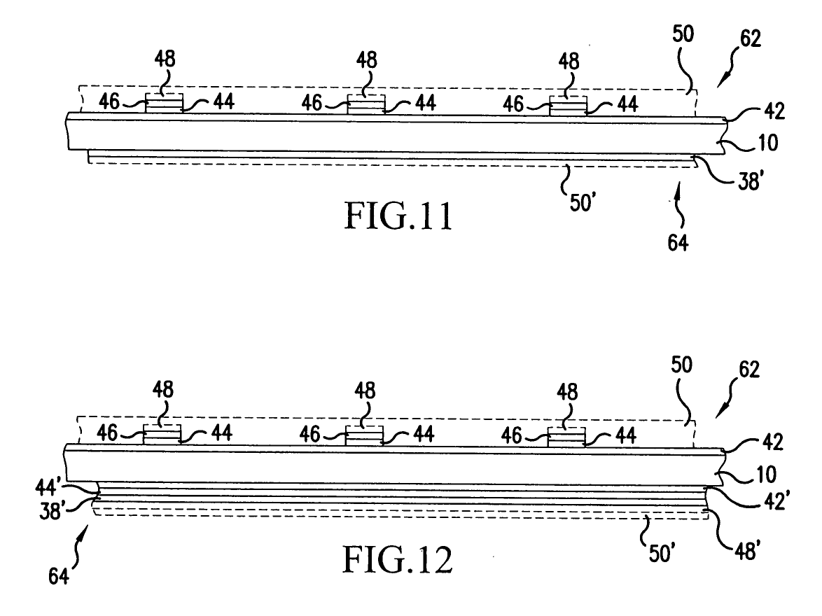

In the first embodiment discussed above with regard to FIG. 6, a dielectric layer 40 was applied on substrate 10. However, this dielectric layer can be omitted and the paper itself can act as a dielectric layer. This will be explained with regard to the second embodiment shown in FIG. 11. Like the first embodiment, this second embodiment includes a substrate 10. This substrate can be any of the above-discussed substrates including paper. If paper were used, for example, the paper would have titanium dioxide or barium titanate therein which would increase the dielectric constant. Such paper is known, however, such paper has not been used in the display environment as is contemplated with the present invention. Other suitable substrates that would replace the dielectric material can also be used. In the embodiment of FIG. 11, the first conductive lines 38′ are printed on an opposed side of the substrate 10. While these lines have been designated by reference number 38′, they are the same as the first conductive lines 38 discussed above, except they are on a second side 64 of substrate 10, as opposed to a first side 62. While FIG. 11 shows the first side 62 as being an upper side and the second side 64 of substrate 10 being a lower side, this is merely due to the orientation of the figure. It should be understood that these are merely opposed sides of the substrate 10.

On the first side 62 of substrate 10, the phosphor-containing layer 42 is provided. This layer is in direct contact with the substrate 10. Then, similarly to the first embodiment, the smoothing layer 44, second conductive lines 46 and optional diffusion layer 48 are provided. Also, the optional protective layer 50 can be provided on this first side 62 of the substrate.

As mentioned above, the second side 64 of the substrate 10 has the first conductive lines 38′ in contact therewith. An optional protective layer 50 can also be place over the first conductive lines 38 in order to protect them. Like the protective layer 50 on the first side 62, this protective layer 50′ on the second side 64 can be omitted if so desired.

When a field is generated through the conductive lines 38′ and 46, the adjacent phosphor will be illuminated, as has been explained above. In the second embodiment of FIG. 11, the dielectric layer 40 has simply been omitted. The substrate 10 instead acts as the dielectric layer. This can save materials and steps in manufacturing.

Turning now to FIG. 12, a third embodiment of an illuminatable substrate is shown. Similarly to the first and second embodiments, the substrate 10 can be various materials. Also, like the second embodiment of FIG. 11, the first side 62 of the substrate has the phosphor-containing layer 42 adjacent the substrate 10. The smoothing layer 44, second conductive lines 46 and diffusion layer 48 can be provided. A protective layer 50 is also shown. The diffusion layer 48 and/or the protective layer 50 can be omitted, as has been discussed above.

On the second side 64 of the substrate 10, another phosphor-containing layer 42′ is provided. Adjacent this layer are a smoothing layer 44′ and then the first conductive lines 38′. An optional diffusion layer 48′ and optional protection layer 50′ are also shown in this third embodiment. Basically, in the third embodiment, the substrate 10 is arranged so that both sides are illuminatable. Phosphor-containing layers 42 and 42′ are provided on both sides. When current is passed though the first conductive line 38′ and the second conductive lines 46, the portion of the phosphor-containing layers 42 and 42′ therebetween will be illuminated.

The third embodiment of FIG. 12 can therefore have an image such as shown in FIG. 1, provided on both sides of the substrate. The image could be a first image on side 62 and a mirror image on side 64, for example. Alternatively, two different images could be provided. For example, an image which is a mirror and identical (but not reversed) on both sides 62 and 64 can be provided. Another design arrangement could be to provide an interrupted portion in either or both of the phosphor-containing layers 42 and 42′. For example, side 62 of the substrate 10 can have a phosphor-containing layer 42 in a certain area which has the image for side 62. On the second side 64, the first conductive line 38′ would have a phosphor-containing layer 42′ adjacent thereto in the areas. The first and second lines 38′ and 46 would be arranged to overlie each other for the images on both sides 62 and 64. If the image on the side 64 is illuminated, the areas on the opposed side 62 would simply not have phosphor-containing layer 42 would be provided in order to illuminate the image on this side 62. Of course, if areas on both sides 62, 64 had all or a portion of the image overlapping, then in these areas, both sides would have phosphor-containing layers. Instead of an image such as 12 as shown in FIG. 1 being illuminated on both sides of 62, 64 of substrate 10, a pixilated image could also be provided. Many different images are possible with the present invention.

Using the substrate 10 as both a carrier and a dielectric has several advantages. First, it can provide a two-sided display. It can also reduce manufacturing cost and simplify the process. By optimizing the dielectric properties of the substrate, the luminance of the display can be dramatically increased. The substrate 10 can be an ultra thin paper such as 10-20 microns instead of a usual 40-50 microns. The paper can be highly filled with a dielectric such as titanium dioxide, TiO₂. The paper can also be coated on both sides with a substance to increase resistance to dielectric breakdown. This substance can be CaCO₃, for example. In another design, the paper can be coated on both sides with a litho coating for surface smoothness enhancement and minimization of surface porosity.

If TiO₂ is used, it has a high dielectric constant which can be in the range of 60 to 114 depending on the source. The dielectric strength, however, is very low (only 0.06×10⁸ V/m.). Therefore, a combination of materials can be used such as TiO₂/CaCO₃, in combination, if desired. However, a highly filled sheet can be manufactured with TiO₂ as filler and since it is physically separated from the phosphor, it should contribute significantly to the dielectric constant of the substrate without reducing significantly its dielectric strength.

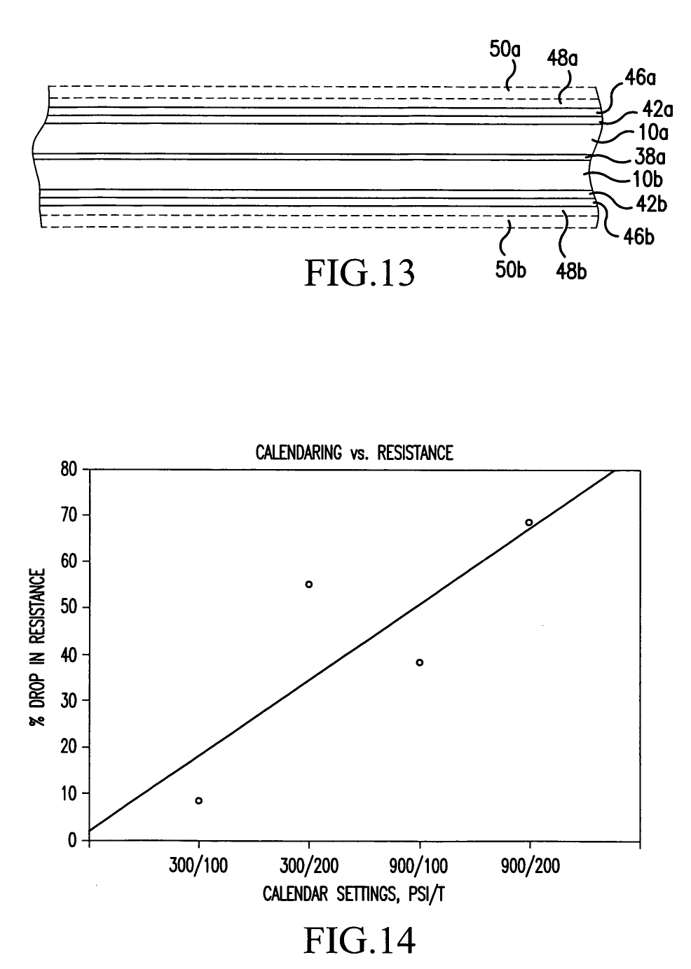

Another way to arrive at a two-sided display is to produce two different substrates as shown in FIG. 6 and laminate the two substrates with the display sides facing away from on another as shown in FIG. 15. Apart from lamination, other known ways to adhere the substrates can be utilized. A different embodiment for a two-sided display will be discussed below with regard to FIG. 13.

The two-sided display of the embodiment of FIG. 15 can also be obtained with a single substrate 10. The dotted line in FIG. 15 merely indicates that this can optionally be two substrates laminated together as discussed above or can be a single substrate 10. However, opposed sides of the substrate 10 or laminated substrates can each have a first conductive layer 38, 38′ applied on each side as shown in FIG. 15. On these conductive layers 38, 38′, dielectric layers 40, 40′ can be applied. As with the above-described embodiments, a single dielectric layer or multiple dielectric layers 40a, 40b, 40a′ and 40b′ can be applied on either or both sides of the substrate 10. Then phosphor-containing layers 42, 42′ and smoothing layers 44, 44′ can be applied. On the smoothing layers 44, 44′, the second conductive lines 46, 46′ can be applied. Optional diffusion layers 48, 48′ and protective layers 50, 50′ can be applied to either or both sides of the substrate 10. The formation of the FIG. 15 embodiment can be done similarly to the above-described embodiments, but the opposed sides of the substrate will have a display. This application of layers to the substrate can be done simultaneously or sequentially. Also, a display with pixels or other images can be provided on the opposed sides of the substrate 10. The displays can be coordinated through the control 34 or each independently controlled.

As described in the embodiments above, this substrate 10 or adhered two substrates of the FIG. 15 embodiment can be calendared or have a coating applied thereto. After application of one or both of the first layers 38, 38′ the substrate can be calendered to crush the ink and help ensure an electrical connection through the conductive particles in these layers.

A two-web press can be used for both printing and coating each side of the substrate. This can be a multicolor press. Two webs can be simultaneously run through a press. These webs will be the substrate and can be paper or any desired material. A two-sided display will be obtained from this process as shown in FIG. 13. A first web would form the first substrate 10a. This substrate 10a can have its bottom side printed with a first conductor 38a and then a phosphor-containing layer 42a can be coated or printed on the opposite side of the first substrate 10a. After the phosphor-containing layer 42a, the top or opposite side of the first web can then be printed or coated with another conductor layer 46a. The bottom side of the second substrate 10b can be printed or coated with a phosphor-containing layer 42b whereafter the bottom side of substrate 10b is printed or coated with a bottom conductor layer 46b. The top side of substrate 10b can then be laminated to the bottom side of substrate 10a with the common conductor layer 38a being therebetween. This lamination or other joining of the substrates 10a, 10b can be done while the common (rear) conductor layer 38a is still wet. If needed, adhesives may be used in the lamination process.

As FIG. 13 further shows, an optional diffusion layer 48a can be applied on the top conductor layer 46a and an optional diffusion layer 48b can be applied on the bottom conductor layer 46b. Also, optional protective layers 50a and 50b can also be used. These diffusion layers 48a, 48b and protective layers 50a, 50b act similarly to the diffusion and protective layers discussed above. Moreover, while substrate 10a has been referred to as a “top” substrate and substrate 10b, as a “bottom” substrate, it should be appreciated that these substrates could actually be flipped. For example, the common conductive layer 38a could be applied on the top of the bottom substrate 10b and then the top substrate 10a adhered thereto.

This two-sided display of FIG. 13 could be a mirror image display or two independent displays. The substrates 10a, 10b can act as dielectric layers between the first conductive layer 38a and the two separate conductive layers 46a and 46b. These substrates 10a, 10b can be formed from webs of paper which can be calendered and/or coated as explained above. The paper can be filled with titanium dioxide and/or barium titanate to increase dielectric constant as also explained above. The lines in the first layer 38a and in the second layers 46a, 46b are shown extending in a same direction in FIG. 13. However, the lines in the first layer 38a could be perpendicular to the lines in the second layers 46a, 46b as has been explained above. Then a display with pixels on both sides of the combined substrate could be obtained.

Rather than printing or coating the various smoothing layers, it is possible to also use a foil stamping process to apply these layers to the substrate.

It is possible for the invention to be used as a simple light. One side such as 62 could have the phosphor-containing layer 42 in order to provide illumination from that one side. The substrate 10 could be rolled into a tube, for example, in order to provide an illuminated tube. Other shapes and configurations for the substrate 10 are possible. The third embodiment of FIG. 12 could also be used as a simple light. Both sides of the substrate 10 and the third embodiment would then simply be illuminated. This could be done simultaneously, sequentially or separately.

Apart from a light, the present invention 12 could be used as a banner. This banner would have different text or images on each side or could have a changing design. For example, the controller 34 could first illuminate a first image on side 62 and thereafter illuminate a second image on side 64. These images can be simultaneously illuminated or illuminated in a desired pattern. Also, multiple images can be provided on either or both sides 62, 64. Also, as noted above, a pixilated display can be provided on both sides of the substrate 10.

While the use of a phosphor-containing layer has been discussed to light up the image, it is possible that the present invention will merely change the way the image is shown. Techniques, such as the use of differently charged, encapsulated inks are possible whereby the printing can be readily visible or blend into the substrate. In other words, the ink would have multiple colors, for example black and white. When the ink at a particular location received a signal, such a supply of current, encapsulated particles in the ink would be oriented to show the black side of the particle. If the signal were not received at a second location, the particles would show their white side and blend into the substrate. Using a pixilated display would enable different images to appear on a substrate. Therefore, variable images could be shown. Such techniques can be used with or separately from the luminescent display whereby these variable images are similarly energized and highlighted.

With regard to the color display, it is possible to use a colored phosphorous material. For example, some phosphoresces are available which will illuminate in certain color. Therefore, by using such a pure phosphorous, it would be possible to have a certain color illumination.

Another way to achieve a color display is to print translucent ink over the area to be illuminated. The ink could be of a certain color so that it would act to filter light emitting therethrough. For example, the primary colors red, green and yellow could be filtered in different ways in order to produce a different color display. In a pixilated display, adjacent pixels could emit different colors in order to provide an overall varying color display. Such light filtering techniques can enable colors of different displays. In a pixilated display, there could be 225 pixels per square inch, for example. If three different colors were being filtered, then 75 pixels per inch would be utilized for a particular color. While primary colors red, green and blue have been discussed; any color combination can be utilized. The use of colors does not have to be limited to three particular colors but can be any desired combination.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method for making a display having a self-illuminatable image thereon, the method comprising the steps of:
providing a substrate;
calendering the substrate;
applying an image to be illuminated on the substrate after the step of calendering; and
providing an electrical connection to supply power to the image when the image is to be illuminated.

2. The method of claim 1, further comprising the step of coating the substrate before the step of calendering to thereby seal and smooth the substrate.

3. The method of claim 2, wherein the step of coating the substrate comprises applying at least one of calcium carbonate and kaolin to the substrate.

4. The method of claim 1, further comprising the step of increasing resolution of the image by coating the substrate before the step of applying the image.

5. The method of claim 2, wherein the step of coating further comprises the step of at least one of varnishing the substrate, coating the substrate with aqueous coating and coating the substrate with ultraviolet curable coating before the step of calendering to thereby seal and smooth the substrate.

6. The method of claim 1, wherein the step of applying an image comprises the step of printing the image on the substrate.

7. The method of claim 6, wherein the step of printing includes the steps of printing a first layer on the substrate and then printing a second layer on the substrate, at least a portion of the first layer being directly below a portion of the second layer such that the first and second layers overlap at portions of the image to be illuminated, the first and second layers being a part of the electrical connection.

8. The method of claim 7, wherein the first and second layers are printed with conductive ink and wherein the method further comprises the steps of:
providing a controller for controlling illumination of the image; and
connecting the first layer to the controller; and
connecting the second layer to the controller.

9. The method of claim 8, further comprising the steps of providing a power source on the substrate to drive the controller and illuminate the display.

10. The method of claim 7, wherein the first layer is printed as a series of parallel lines and the second layer is printed as a series of parallel lines perpendicular to the lines of the first layer whereby the image to be illuminated includes a plurality of pixels.

11. The method of claim 7, wherein the first layer and second layer are overlapping images.

12. The method of claim 7, further comprising the step of using paper as the substrate.

13. The method of claim 7, wherein at least the second layer is printed with conductive ink and wherein the method further comprising the step of reducing an amount of conductive ink used in the second layer by providing a smoothing layer beneath the second layer, the smoothing layer providing a relatively flat surface to print the second layer of conductive ink.

14. The method of claim 13, wherein a shape of the smoothing layer matches a shape of the second layer.

15. The method of claim 14, wherein the smoothing layer is a conductive layer.

16. The method of claim 13, further comprising the steps of:
providing at least one dielectric layer on a side of the first layer opposite to the substrate;
placing a phosphor-containing layer on the at least one dielectric layer;
providing the smoothing layer on a side of the phosphor-containing layer opposite the dielectric layer; and
printing the second layer on a side of the smoothing layer opposite the phosphor-containing layer.

17. The method of claim 16, wherein a plurality of dielectric layers are provided.

18. The method of claim 1, further comprising the step of using paper as the substrate.

19. The method of claim 1, wherein the step of applying the image further comprises the steps of:
printing a first layer on the substrate;
providing at least one dielectric layer over the first layer;
providing a phosphor-containing layer on a top of the at least one dielectric layer; and
printing a second layer above the at least one dielectric layer, the first and second layers being a part of the electrical connection.

20. The method of claim 19, further comprising the step of providing a smoothing layer between the second layer and the phosphor-containing layer.

21. The method of claim 19, further comprising the step of providing a diffusion layer on the second layer to increase uniformity of emitted light.

22. The method of claim 19, wherein the first and second layers are printed with conductive ink and wherein overlapping portions of the first and second layers form the image to be illuminated.

23. The method of claim 1, wherein the step of applying the image further comprises the steps of:
printing a first layer on a first side of the substrate;
providing a phosphor-containing layer on an opposite side of the substrate; and
printing a second layer on the side of the substrate with the phosphor-containing layer,
whereby the substrate is a dielectric layer.

24. The method of claim 23, further comprising the step of using paper as the substrate, the paper containing at least one of titanium dioxide and barium titanate to increase dielectric constant.

25. The method of claim 23, further comprising the step of providing a smoothing layer between the second layer and the phosphor-containing layer.

26. The method of claim 23, further comprising the step of providing a diffusion layer on the second layer to increase uniformity of emitted light.

27. The method of claim 23, wherein the first and second layers are printed with conductive ink and wherein overlapping portions of the first and second layers form the image to be illuminated.

28. The method of claim 1, wherein the step of applying the image further comprises the steps of:
providing a phosphor-containing layer on each side of the substrate, the substrate having a first side and a second side;
printing a first layer on a first one of the phosphor-containing layers on the first side of the substrate; and
printing a second layer on a second one of the phosphor-containing layers on the second side of the substrate,
whereby the substrate is a dielectric layer.

29. The method of claim 28, further comprising the step of using paper as the substrate, the paper containing at least one of titanium dioxide and barium titanate to increase dielectric constant.

30. The method of claim 29, further comprising the step of coating the paper to increase electrical breakdown resistance.

31. The method of claim 30, comprising the step of using at least one of calcium carbonate and kaolin in the coating.

32. The method of claim 28, further comprising the step of providing a smoothing layer between the first layer and the first phosphor-containing layer and providing another smoothing layer between the second layer and the second phosphor-containing layer.

33. The method of claim 28, further comprising the step of providing a diffusion layer on the first layer and providing a diffusion layer on the second layer, the diffusion layers increasing uniformity of emitted light.

34. The method of claim 28, wherein the first and second layers are printed with conductive ink and wherein overlapping portions of the first and second layers form the image to be illuminated.

35. The method of claim 1, wherein the step of applying the image further comprises the steps of:
printing a first layer of conductive ink on the substrate, the first layer being a part of the electrical connection; and
calendering the substrate and the first layer after the step of printing to thereby crush the conductive ink to connect conductive particles in the ink to ensure a continuous electrical connection through the first layer.

36. The method of claim 35, further comprising the step of applying heat to the substrate during the step of calendering to decrease the viscosity of the conductive ink.

37. The method of claim 36, wherein the temperature is in the range of 100-200° C.

38. The method of claim 36, wherein the pressure is in the range of 200-1000 psi.

39. The method of claim 35, further comprising the step of printing a second layer of conductive ink on the substrate, at least a portion of the first layer being directly below a portion of the second layer such that the first and second layer overlap at portions of the image to be illuminated.

40. A method for making a display having a self-illuminatable image, the method comprising the steps of:
providing a substrate;
placing a first layer of conductive ink on the substrate, the conductive ink having a plurality of conductive particles; and
applying pressure to the substrate and conductive ink to connect the conductive particles in the ink to ensure a continuous electrical connection through the first layer and therefore increase electrical conductivity of the first layer.

41. The method of claim 40, further comprising the step of applying temperature to the substrate during the step of applying pressure to decrease viscosity of the conductive ink.

42. The method of claim 41, wherein the temperature is in the range of 100-200° C.

43. The method of claim 41, wherein the pressure is in the range of 200-1000 psi.

44. The method of claim 40, further comprising the step inducing contact of conductive particles in the conductive ink by cooling the substrate and conductive ink after the step of applying pressure.

45. The method of claim 40, further comprising the step of calendering the paper before the step of placing a first layer of conductive ink.

46. The method of claim 45, further comprising the step coating the substrate before the step of calendering to thereby seal and smooth the substrate.

47. The method of claim 46, wherein the step of coating the substrate comprises applying at least one of calcium carbonate and kaolin to the substrate.

48. The method of claim 40, further comprising the step of increasing resolution of the image by coating the substrate before the step of applying the image.

49. The method of claim 48, wherein the step of coating further comprises the step of at least one of varnishing the substrate, coating the substrate with aqueous coating and coating the substrate with ultraviolet curable coating before the step of placing the first layer of ink to thereby seal and smooth the substrate.

50. The method of claim 40, wherein the step of applying pressure comprises calendering the substrate with the first layer of conductive ink.

51. The method of claim 40, further comprising the step of using paper as the substrate.

52. The method of claim 40, further comprising the step of placing a second layer of conductive ink on the substrate, at least a portion of the first layer being directly below a portion of the second layer such that the first and second layers overlap at portions of the image to be illuminated.

53. The method of claim 52, wherein the step of placing the first layer comprises printing the first layer on the substrate, the first layer being printed as a series of parallel lines and the second layer being printed as a series of parallel lines perpendicular to the lines of the first layer whereby the image to be illuminated includes a plurality of pixels.

54. The method of claim 52, wherein the step of placing the first layer comprises printing the first layer on the substrate, the first layer and the second layer being overlapping images.

55. The method of claim 52, further comprising the step of providing a smoothing layer beneath the second layer to provide a flat surface for the second layer of conductive ink.

56. The method of claim 55, wherein a shape of the smoothing layer matches a shape of the second layer, the smoothing layer being a conductive layer.

57. The method of claim 55, further comprising the steps of:
providing at least one dielectric layer on a side of the first layer opposite to the substrate;
placing a phosphor-containing layer on the at least one dielectric layer; and
printing a second layer of conductive ink on the smoothing layer,
at least a portion of the first layer and the second layer overlap at portions of the image to be illuminated.

58. The method of claim 57, further comprising the step of providing a smoothing layer between the phosphor-containing layer and the second layer of conductive ink.

59. The method of claim 57, further comprising the step of providing a diffusion layer on the second layer to increase uniformity of emitted light.

60. The method of claim 40, wherein the step of placing the first layer of conductive ink comprises printing the first layer on a first side of the substrate, the method further comprising the steps of:
providing a phosphor-containing layer on a second side of the substrate, the first side being opposite to the second side of the substrate; and
printing a second layer of conductive ink on the phosphor-containing layer,
whereby the substrate is a dielectric layer.

61. The method of claim 40, wherein the substrate has a first and second side, the first side being opposite the second side of the substrate and wherein the method further comprise the steps:
providing a phosphor-containing layer on each side of the substrate,
the first layer of conductive ink being placed on the phosphor-containing layer on the first side of the substrate by printing; and
printing a second layer of conductive ink on the phosphor-containing layer on the second side of the substrate,
whereby the substrate is a dielectric.

62. The method of claim 40, further comprising the step of applying heat during the step of applying pressure to the substrate and conductive ink to further connect the conductive particles in the first layer and therefore increase electrical conductivity of the first layer.

63. A display having a self-illuminatable image, the display comprising:
a substrate;
a first layer of conductive ink printed on a first side of the substrate;
a phosphor-containing layer on an opposite side of the substrate; and
a second layer of conductive ink printed on the side of the substrate with the phosphor-containing layer,
whereby the substrate is a dielectric layer.

64. The display of claim 63, wherein the substrate is calendered before the printing of the first layer of conductive ink.

65. The display of claim 63, wherein the substrate is coated before printing of the first layer of conductive ink to thereby seal and smooth the substrate.

66. The display of claim 65, wherein the coating is at least one of calcium carbonate and kaolin.

67. The display of claim 63, wherein the substrate is paper, the paper containing at least one of titanium dioxide and barium titanate to increase dielectric constant.

68. The display of claim 67, further comprising a coating applied to the surface of the substrate, the coating increases electrical breakdown resistance.

69. The display of claim 68, wherein the coating is at least one of calcium carbonate and kaolin.

70. The display of claim 63, wherein the substrate is flexible paper.

71. The display of claim 70, wherein the paper has a thickness of 40 microns or less.

72. The display of claim 67, wherein the paper has a thickness of 10 microns or less.

73. The display of claim 63, further comprising another phosphor-containing layer on the first side of the substrate, the first layer of conductive ink being on the phosphor-containing layer on the first side of the substrate whereby an illuminatable display is provided on both sides of the substrate.

74. The display of claim 73, further comprising diffusion layers on both the first layer of conductive ink and the second layer of conductive ink to increase uniformity of emitted light.

75. The display of claim 63, further comprising a diffusion layer on the second layer of conductive ink to increase uniformity of emitted light.

76. A display having a self-illuminatable image, the display comprising:
a substrate;
a first layer of conductive ink;
a second layer of conductive ink, at least a portion of the first layer being below a portion of the second layer such that the first and second layers overlap at portions of the image to be illuminated;
a phosphor-containing layer provided between the first and second layers of conductive ink;
a source for supplying an electrical current to both the first and second layers, phosphor in the phosphor-containing layer being excited to be illuminated in areas of the overlap between the first and second layers; and
a diffusion layer being provided above the second layer of conductive ink to increase uniformity of light emitted by the phosphor-containing layer.

77. The display of claim 76, wherein the first layer of conductive ink is printed on the substrate and wherein the substrate is calendered before the printing of the first layer of conductive ink.

78. The display of claim 76, wherein first layer of conductive ink is printed on the substrate and wherein the substrate is coated before printing of the first layer of conductive ink to thereby seal and smooth the substrate.

79. The display of claim 78, wherein the coating is at least one of calcium carbonate and kaolin.

80. The display of claim 76, wherein the substrate is paper.

81. The display of claim 80, wherein the diffusion layer includes at least one of calcium carbonate and kaolin.

82. The display of claim 76, further comprising at least one dielectric layer between the first layer and the phosphor-containing layer.

83. The display of claim 76, wherein the first layer is on one side of the substrate and the second layer is on an opposite side of the substrate whereby the substrate is a dielectric layer.

84. The display of claim 83, wherein the phosphor-containing layer is a first phosphor-containing layer and wherein the display further comprises a second phosphor-containing layer, the second phosphor-containing layer being on an opposite side of the substrate from the first phosphor-containing layer, whereby illuminatable images are provided on both sides of the substrate.

85. The display of claim 76, wherein the second layer of conductive ink is printed on the display in a predetermined pattern, the pattern comprising a series of crisscrossing lines or a strip having a plurality of openings provided therein.

86. A display having a self-illuminatable image, the display comprising:
a substrate;
a first layer of conductive ink;
a second layer of conductive ink, at least a portion of the first layer being below a portion of the second layer such that the first and second layers overlap at portions of the image to be illuminated;
a phosphor-containing layer provided between the first and second layers of conductive ink;
a source for supplying an electrical current to both the first and second layers, phosphor contained in the phosphor-containing layer being excited to be illuminated in areas of the overlap between the first and second layers; and
a smoothing layer being provided beneath the second layer to increase conductivity and minimize electrical resistance in the second layer, the smoothing layer providing a flat surface for printing the second layer whereby an amount of conductive ink for the second layer can be minimized.

87. The display of claim 86, wherein the first layer of conductive ink is printed on the substrate and wherein the substrate is coated before printing of the first layer of conductive ink to thereby seal and smooth the substrate.

88. The display of claim 87, wherein the coating is at least one of calcium carbonate and kaolin.

89. The display of claim 86, wherein the substrate is paper which is calendered to provide a flat surface whereby the amount of conductive ink for the first layer can be minimized.

90. The display of claim 89, wherein the paper is at least one of varnished, coated with aqueous coating and coated with ultraviolet curable coating to prevent absorption of the conductive ink of the first layer.

91. A method of making a display having a self-illuminatable image thereon, the method comprising the steps of:
providing a substrate;
printing a first layer of conductive ink in a first predetermined pattern on the substrate;
providing a phosphor-containing layer over the first layer of conductive ink;
printing a second layer of conductive ink above the phosphor-containing layer in a second predetermined pattern, the first predetermined pattern and the second predetermined pattern overlapping at portions of the image to be illuminated; and
minimizing an amount of conductive ink used in the second layer by providing a smoothing layer directly beneath the second layer, the smoothing layer providing a flat surface for printing of the second layer of conductive ink.

92. The method of claim 91, further comprising the step of minimizing electrical resistance in the second layer during the step of providing the smoothing layer.

93. The method of claim 91, further comprising the step of providing the same pattern for the first and second pattern.

94. The method of claim 91, wherein the step of printing the first layer comprises printing a series of lines in a first direction and wherein the step of printing the second layer comprising printing a series of lines in a second direction, the first direction being perpendicular to the second direction whereby the image includes a plurality of pixels.

95. The method of claim 91, further comprising the step of calendering the paper before the step of printing a first layer of conductive ink.

96. The method of claim 95, further comprising the step of coating the substrate before the step of calendering to thereby seal and smooth the substrate.

97. The method of claim 96, wherein the step of coating the substrate comprises applying at least one of calcium carbonate and kaolin to the substrate.

98. The method of claim 91, further comprising the step of increasing resolution of the image by coating the substrate before the step of applying the image.

99. The method of claim 98, wherein the step of coating further comprises the step of at least one of varnishing the substrate, coating the substrate with aqueous coating and coating the substrate with ultraviolet curable coating before the step of printing the first layer of conductive ink to thereby seal and smooth the substrate.

100. A two-sided display having a self-illuminatable image, the display comprising:
a first substrate;
a second substrate;
a first conductive layer between the first and second substrates;
a second top conductive layer on a side of the first substrate opposite to the first conductive layer; and
a second bottom conductive layer on a side of the second substrate opposite to the first conductive layer, the first substrate and the second substrate being joined and each substrate being a dielectric between the conductive layers.

101. The two-sided display of claim 100, wherein the first and second substrates are paper containing at least one of titanium dioxide and barium titanate to increase dielectric constant.

102. The two-sided display of claim 101, wherein the substrates are calendered before first conductive layer, the second top conductive layer and the second bottom conductive layer are applied thereto.

103. The two-sided display of claim 102, wherein the substrates have a coating of at least one of calcium carbonate and kaolin.

104. The two-sided display of claim 100, wherein the first conductive layer, the second top conductive layer and the second bottom conductive layer are conductive ink and wherein the first and second substrates are paper.

105. The method of claim 7, further comprising the steps of providing two substrates which have been treated by the recited steps and laminating back sides of the substrates together to form a two-sided display.

106. The method of claim 7, wherein the step of applying an image comprises applying images to both sides of the substrate, the steps of printing the fist layer and printing the second layer being done to both sides of the substrate.

107. The method of claim 63, wherein the display further comprises a first layer, a phosphor-containing layer and a second layer on both sides of the substrate, the substrate being a unitary, one-piece element.

108. The method of claim 63, wherein the display further comprises a first layer, a phosphor-containing layer and a second layer on both sides of the substrate, the substrate being two separate sheets of paper adhered together.
